(19) United States
(12) Patent Application Publication
(10) Pub. No.: US 2011/0237470 A1
(43) Pub. Date: Sep. 29, 2011

(54) METHOD TO DECREASE VISCOSITY OF GELLED OIL

(76) Inventors: Leiming Li, Sugar Land, TX (US); Lijun Lin, Sugar Land, TX (US); Oscar Bustos, Katy, TX (US); Randy Tercero, LaPorte, TX (US); Mathew M. Samuel, Sugar Land, TX (US)

(21) Appl. No.: 12/748,503

(22) Filed: Mar. 29, 2010

(51) Int. Cl. C09K 8/64; C09K 8/68; C09K 8/588; C09K 8/584

(52) U.S. Cl. 507/238; 507/203; 507/260; 507/261; 507/266; 507/239; 507/267

(57) ABSTRACT

A method of decreasing the viscosity of a gelled organic-based fluid is disclosed. The method comprises combining an organic solvent, a gelling agent, and a metal crosslinker; forming the gelled organic-based fluid; and adding a chelating agent forming a complex with the metal to decrease the viscosity of the gelled organic-based fluid. The chelating agent may be chosen within nitrilotriacetic acid (NTA), citric acid; ascorbic acid, hydroxyethylethylenediaminetriacetic acid (HEDTA) or its salts, ethylenediaminetetraacetic acid (EDTA) or its salts, diethylenetriaminepentaacetic acid (DTPA) or its salts, phosphinopolyacrylate, thioglycolates, or a combination thereof.

### FIELD

The invention relates to gelled oils used in treating subterranean formations. More particularly, it relates to gelled oils used in fracturing, sand control, frac packing, pipe cleanup, diversion, coiled tubing cleanout and other well services in the oilfield. Most particularly, it relates to a method of breaking the viscosity of gelled oils by addition of gelled-oil-breaking agent.

### BACKGROUND

The statements in this section merely provide background information related to the present disclosure and may not constitute prior art.

Gelled liquid hydrocarbon fluids have been utilized in a variety of treatments for subterranean formations penetrated by well bores, including stimulation activities such as fracturing and/or gravel packing. Such hydrocarbon fluids must have a sufficiently high viscosity to generate a fracture of sufficient dimensions and also to carry the proppant particles into the fracture. Hydrocarbon fluids are frequently gelled by use of phosphate containing gelling agents, particularly phosphate acid ester gelling agents. These agents have been popular because of their effectiveness and comparatively low cost.

One aspect of well treatment processes is the “cleanup”, e.g., returning and removing used fluid from the well after the treatment has been completed. Returned fluids are also useful to carry and remove waste materials, excess proppant and the like from the well. Techniques for promoting cleanup often involve reducing the viscosity of the treatment fluid as much as practical so that it will more readily flow toward the wellbore. This is called “breaking” the fluid. Breaking agents, or “breakers” are specific to the type of treatment fluid being used. Gel breakers are commonly used for conventional polymer based fluids used in stimulation and other activities since leaving such a high viscosity fluid in the formation would result in a reduction of the formation permeability and, consequently, a decrease in the well production. The most widely used breakers are oxidizers and enzymes. The breakers can be dissolved or suspended in the liquid (aqueous, non-aqueous or emulsion) phase of the treating fluid and exposed to the polymer throughout the treatment (added “internally”), or exposed to the fluid at some time after the treatment (added “externally”). Breaking can occur in the wellbore, gravel pack, filter cake, the rock matrix, in a fracture, or in another added or created environment. See, for example, U.S. Pat. No. 4,741,401 (Walles et al.), assigned to Schlumberger Dowell and incorporated herein by reference, for a detailed discussion of breaking activities.

It has now been found that some components can act as a breaking agent for gelled oils.

### SUMMARY

One embodiment is a method of decreasing the viscosity of a gelled organic-based fluid, comprising combining an organic solvent, a gelling agent, and a metal crosslinker; forming the gelled organic-based fluid; and adding a chelating agent possibly forming a complex with the metal to decrease the viscosity of the gelled organic-based fluid.

A second embodiment is a method of treating a subterranean formation from a well, comprising combining an organic solvent, a gelling agent, and a metal crosslinker; forming the gelled organic-based fluid; introducing the gelled organic-based fluid in to the well; and adding a chelating agent possibly forming a complex with the metal to decrease the viscosity of the gelled organic-based fluid.

The organic solvent may be chosen within diesel oil, kerosene, paraffinic oil, crude oil, refined oil, gas-condensates, LPG, toluene, xylene, ethers, esters, mineral oil, biodiesel, vegetable oil, animal oil, alcohol, or mixtures thereof.

The chelating agent may be chosen within, but not limited to nitrilotriacetic acid (NTA), citric acid; ascorbic acid, hydroxyethylethylenediaminetriacetic acid (HEDTA) or its salts, ethylenediaminetetraacetic acid (EDTA) or its salts such as tetrasodium EDTA (EDTA Na4), diethylenetriaminepentaacetic acid (DTPA) or its salts, phosphinopolyacrylate, thioglycolates, or a combination thereof.

### BRIEF DESCRIPTION OF THE DRAWINGS

FIG. 1 shows viscosity at 93 deg C. for a sample of gelled oil alone and gelled oil mixed with 0.24% NTA (nitrilotriacetic acid).

FIG. 2 shows viscosity at 93 deg C. for a sample of gelled oil alone and gelled oil mixed with 0.24% NTA.

FIG. 3 shows viscosity at 93 deg C. for a sample of gelled oil alone, gelled oil mixed with 0.076% HEDTA (hydroxyethylethylenediaminetriacetic acid), and gelled oil mixed with 0.38% HEDTA, respectively.

FIG. 4 shows viscosity at 77 deg C. for a sample of gelled oil alone and gelled oil mixed with 0.72% wt tetrasodium EDTA (EDTA Na4).

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

The following definitions are provided in order to aid those skilled in the art in understanding the detailed description of the invention.

Fluids and methods using fluids are based upon at least one organic base, such as a hydrocarbon fluid. As used herein, “organic solvent” includes, for example, any organic fluid medium suitable to facilitate ease of reaction and/or intermixing of the disclosed reactants, ease of handling of the disclosed reactants or resulting reaction products, and/or that may be optionally selected to be removable (e.g. by distillation) from a reaction product, following reaction. Organic solvents may be selected to have desired properties relative to the given reactants employed and may be chosen, for example, from any of the hydrocarbon or other organic fluids listed elsewhere herein as suitable for organic base fluids. When used, the hydrocarbon fluid comprises any known hydrocarbon liquid such as crude oil, refined or partially refined oil, fuel oil, liquefied gas, alkanes, alpha-olefins, internal olefins, diesel oil, condensates and combinations of hydrocarbons. In an embodiment the organic solvent is diesel. In other embodiments, diesel can be replaced with a number of other hydrocarbons and solvents: xylene, LPG, toluene, ether, ester, mineral oil, other petroleum distillates, vegetable oil, animal oil, bio-diesel, etc. As used herein, “fatty acid” is a carboxylic acid often with a long unbranched aliphatic tail chain. Fatty acids are aliphatic monocarboxylic acids derived from or contained in esterified form in an animal or vegetable fat, oil or wax. Aliphatics include alkanes (e.g. paraffin hydrocarbons), alkenes (e.g. ethylene) and alkynes (e.g. acetylene). Natural fatty acids commonly have a chain of 4 to 28 carbons (usually unbranched and even-numbered), which may be saturated or unsaturated.

The term “surfactant” refers to a soluble or partially soluble compound that reduces the surface tension of liquids, or reduces inter-facial tension between two liquids, or a liquid and a solid by congregating and orienting itself at these interfaces.

The term “viscoelastic” refers to those viscous fluids having elastic properties, i.e., the liquid at least partially returns to its original form when an applied stress is released.

The phrase “viscoelastic surfactant” or “VES” refers to that class of compounds which can form micelles (spherulitic, anisometric, lamellar, or liquid crystal) in the presence of counter ions in aqueous solutions, thereby imparting viscosity to the fluid. Anisometric micelles can be used, as their behavior in solution most closely resembles that of a polymer.

According to a first aspect, embodiments are disclosed where the gelled organic-based fluid comprises an organic solvent, a phosphate ester, and a metal crosslinker.

The organic solvent may be any known component according to the definition above. In some embodiments the organic solvent is hydrocarbon liquid such as crude oil, refined or partially refined oil, fuel oil, liquefied gas, alkanes, alpha-olefins, internal olefins, diesel oil, condensates and combinations of hydrocarbons.

The gelled organic based fluid comprises a phosphate ester. The phosphate ester may be an alkyl phosphate ester or an orthophosphate ester gelling agent. Such gelling agent is typically formed from a mixture of primary mono-hydric alcohols having carbon chains of from about 3 to about 18 carbon atoms. The alcohols are reacted with phosphates such as phosphorous pentoxide and/or trimethyl phosphate to produce mono-alkyl, di-alkyl, and/or tri-alkyl esters. These gelling agents are effective viscosifiers in a wide range of organic solvent types, and are most effective when neutralized (i.e., no excess presence of base or acid). Specific alkyl phosphate ester gelling agents include C3-18 (preferably C6-10) alkyl diester acids, C8-10 alkyl diester acid, mixtures of the above, and analogous mono and diesters. Such alkyl phosphate esters or diesters are typically prepared by reacting a C3-18 aliphatic alcohol with phosphorous pentoxide. The phosphate intermediate interchanges its ester groups with triethyl phosphate with triethylphosphate producing a more broad distribution of alkyl phosphate esters. Alternatively, the gelling agent may be made by admixing with an alkyl diester, a mixture of low molecular weight alkyl alcohols or diols. The low molecular weight alkyl alcohols or diols preferably include C6 to C10 alcohols or diols. The alcohol mixture, however, will contain from 0.05 to 5.0 wt %, preferably from 0.1 to 3.0 wt % of the high molecular weight alcohol or diol. The low molecular weight alcohols (or diols) and the high molecular weight alcohols (or diols) may be added as a mixture or added separate in the production of the phosphate ester.

When used as a gelled organic based fluid, the fluid further contains a crosslinking agent. The crosslinker can be aluminum or ferric crosslinkers. Other type of metal crosslinker can be used, the metal being a multivalent metal such as boron, zinc, copper, iron, magnesium, calcium, barium, titanium, zirconium, tin, cobalt and so forth, and mixtures thereof, or a metal alkoxide, complexed to carboxylic acid groups.

When an aluminum crosslinker is used, examples of phosphate esters useful in forming the aluminum salts are 7,10-dioxadodecyl-y-oxanonyl phosphate; bis(7,10-dioxadodecyl)phosphate; bis(7-oxanonyl)phosphate; 7-oxanonyl-2-oxabutyl phosphate; 5-oxanonyl-3-oxapentyl phosphate; 11-oxamidecyl phosphate; 5-oxaheptyl-9-oxaundecanyl phosphate; 13-methyl-11-oxamidecanyl phosphate; 11,14-dimethyl 9,12-dioxatetradecyl 4-oxahex-1-enyl phosphate; 4,7-dioxanonyl-8-oxadecyl phosphate; 7-oxanonyl octyl phosphate; 6-oxaoctyl methyl phosphate; 5-methyl-7,10-dioxadodecyl tetradecyl phosphate; 3-oxapentyl octyl phosphate; 6-butyl-12-methyl-10-oxadodecyl octyl phosphate; and 4-methyl-2-oxabutyl nonyl phosphate.

Some small amount of sodium hydroxide and water can be added to increase the pH to optimum gelling range at the time the aluminum compound is mixed. The final pH should be partially acidic. The phosphate ester and crosslinking agent at the proper pH react in the oil to gel the oil.

In most applications the concentration of the gelling agent will be from 0.05 to 4.0 wt %, preferably 0.5 to 2.0 wt %, of the oil-base liquid.

In a second aspect, the gelled organic-based fluid can further comprise a viscoelastic surfactant to gel sufficiently, or to have a sufficient increase in viscosity. The resultant combination is liquid. The gelled organic-based fluid may also contain in another embodiment gel stabilizers, including but not limited to a source of basic aluminum such as sodium aluminate, aluminum alkoxides or aluminum acetate to assist in formation of the gel structure.

The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which is incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

Non-limiting examples of suitable viscoelastic surfactants useful for viscosifying some fluids include cationic surfactants, anionic surfactants, zwitterionic surfactants, amphoteric surfactants, nonionic surfactants, and combinations thereof.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to about 10 if m is 0; a′ and b′ are each 1 or 2 when m′ is not 0 and (a′+b′) is from 1 to about 5 if m is 0; (m+m′) is from 0 to about 14; and CH₂CH₂O may also be OCH₂CH₂.

In an embodiment, a zwitterionic surfactant of the family of betaine is used. Two suitable examples of betaines are BET-O and BET-E. The surfactant in BET-O-30 is shown below; one chemical name is oleylamidopropyl betaine. It is designated BET-O-30 because as obtained from the supplier (Rhodia, Inc. Cranbury, N.J., U.S.A.) it is called Mirataine BET-O-30 because it contains an oleyl acid amide group (including a C₁₇H₃₃ alkene tail group) and contains about 30% active surfactant; the remainder is substantially water, sodium chloride, and propylene glycol. An analogous material, BET-E-40, is also available from Rhodia and contains an erucic acid amide group (including a C₂₁H₄₁ alkene tail group) and is approximately 40% active ingredient, with the remainder being substantially water, sodium chloride, and isopropanol. VES systems, in particular BET-E-40, optionally contain about 1% of a condensation product of a naphthalene sulfonic acid, for example sodium polynaphthalene sulfonate, as a rheology modifier, as described in U.S. Patent Application Publication No. 2003-0134751. The surfactant in BET-E-40 is also shown below; one chemical name is erucylamidopropyl betaine. As-received concentrates of BET-E-40 were used in the experiments reported below, where they will be referred to as “VES”. BET surfactants, and other VES's that are suitable, are described in U.S. Pat. No. 6,258,859. According to that patent, BET surfactants make viscoelastic gels when in the presence of certain organic acids, organic acid salts, or inorganic salts; in that patent, the inorganic salts were present at a weight concentration up to about 30%. Co-surfactants may be useful in extending the brine tolerance, and to increase the gel strength and to reduce the shear sensitivity of the VES-fluid, in particular for BET-O-type surfactants. An example given in U.S. Pat. No. 6,258,859 is sodium dodecylbenzene sulfonate (SDBS), also shown below. Other suitable co-surfactants include, for example those having the SDBS-like structure in which x=5-15; preferred co-surfactants are those in which x=7-15. Still other suitable co-surfactants for BET-O-30 are certain chelating agents such as trisodium hydroxyethylethylenediamine triacetate. The rheology enhancers may be used with viscoelastic surfactant fluid systems that contain such additives as co-surfactants, organic acids, organic acid salts, and/or inorganic salts.

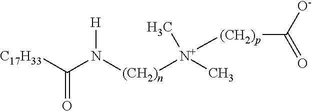

Surfactant in BET-O-30 (when n=3 and p=1)

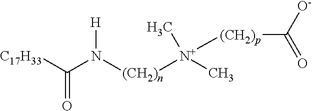

Surfactant in BET-E-40 (when n=3 and p=1)

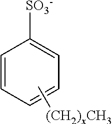

SDBS (when x=11 and the counter-ion is Na⁺)

Some embodiments use betaines; most preferred use BET-E-40. Although experiments have not been performed, it is believed that mixtures of betaines, especially BET-E-40, with other surfactants are also suitable. Such mixtures are within the scope of embodiments.

Other betaines that are suitable include those in which the alkene side chain (tail group) contains 17-23 carbon atoms (not counting the carbonyl carbon atom) which may be branched or straight chained and which may be saturated or unsaturated, n=2-10, and p=1-5, and mixtures of these compounds. More preferred betaines are those in which the alkene side chain contains 17-21 carbon atoms (not counting the carbonyl carbon atom) which may be branched or straight chained and which may be saturated or unsaturated, n=3-5, and p=1-3, and mixtures of these compounds. These surfactants are used at a concentration of about 0.5 to about 10%, preferably from about 1 to about 5%, and most preferably from about 1.5 to about 4.5%.

Exemplary cationic viscoelastic surfactants include the amine salts and quaternary amine salts disclosed in U.S. Pat. Nos. 5,979,557, and 6,435,277 which have a common Assignee as the present application and which are hereby incorporated by reference. Examples of suitable cationic viscoelastic surfactants include cationic surfactants having the structure:

R₁N⁺(R₂)(R₃)(R₄)X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Cationic surfactants having the structure R₁N⁺(R₂)(R₃)(R₄) X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). As received commercially available VES surfactant concentrate formulations, for example cationic VES surfactant formulations, may also optionally contain one or more members of the group consisting of alcohols, glycols, organic salts, chelating agents, solvents, mutual solvents, organic acids, organic acid salts, inorganic salts, oligomers, polymers, co-polymers, and mixtures of these members. They may also contain performance enhancers, such as viscosity enhancers, for example polysulfonates, for example polysulfonic acids, as described in U.S. Pat. No. 7,084,095 which is hereby incorporated by reference.

Another suitable cationic VES is erucyl bis(2-hydroxyethyl)methyl ammonium chloride, also known as (Z)-13 docosenyl-N—N-bis(2-hydroxyethyl)methyl ammonium chloride. It is commonly obtained from manufacturers as a mixture containing about 60 weight percent surfactant in a mixture of isopropanol, ethylene glycol, and water. Other suitable amine salts and quaternary amine salts include (either alone or in combination), erucyl trimethyl ammonium chloride; N-methyl-N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

Many fluids made with viscoelastic surfactant, for example those containing cationic surfactants having structures similar to that of erucyl bis(2-hydroxyethyl)methyl ammonium chloride, inherently have short re-heal times and the rheology enhancers may not be needed except under special circumstances, for example at very low temperature.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant may also be based upon any suitable anionic surfactant. In some embodiments, the anionic surfactant is an alkyl sarcosinate. The alkyl sarcosinate can generally have any number of carbon atoms. Presently preferred alkyl sarcosinates have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

Chelation is the formation or presence of two or more separate bindings between a multiple-bonded ligand and a single central atom. Usually these ligands are organic compounds, and are called chelating agents, chelants, or chelators. A chelating agent forms complex molecules with certain metal ions, inactivating the ions so that they cannot normally react with other elements or ions to produce precipitates or scale. For example, nitrilotriacetic acid (NTA, an easily biodegradable chelating agent) can form coordination compounds with metal ions such as Ca²⁺, Cu²⁺ or Fe³⁺ similar to EDTA. A chelating agent is added to the gelled organic-based fluid to possibly form a complex with the metal in the metal crosslinker to decrease the viscosity of the gelled organic-based fluid. The breaker is suitable for reducing viscosity of the gels. The chelating agent may also prevent or remove iron scale downhole. Example of chelating agent used as breaker are: nitrilotriacetic acid (NTA); citric acid; ascorbic acid; hydroxyethylethylenediaminetriacetic acid (HEDTA) and its salts, including sodium, potassium, and ammonium salts; ethylenediaminetetraacetic acid (EDTA) and its salts, including sodium, potassium, and ammonium salts; diethylenetriaminepentaacetic acid (DTPA) and its salts, including sodium, potassium, and ammonium salts; phosphinopolyacrylate; thioglycolates; and a combination thereof. Other chelating agent used as breaker are: aminopolycarboxylic acids and phosphonic acids and sodium, potassium and ammonium salts thereof; HEIDA (hydroxyethyliminodiacetic acid); other aminopolycarboxylic acid members, including already EDTA and NTA (nitrilotriacetic acid), but also: DTPA (diethylenetriamine-pentaacetic acid), and CDTA (cyclohexylenediamintetraacetic acid) are also suitable; phosphonic acids and their salts, including ATMP (aminotri-(methylenephosphonic acid)), HEDP (1-hydroxyethylidene-1,1-phosphonic acid), HDTMPA (hexamethylenediaminetetra-(methylenephosphonic acid)), DTPMPA (diethylenediaminepenta-(methylenephosphonic acid)), and 2-phosphonobutane-1,2,4-tricarboxylic acid. These phosphonic acids are available from Solutia, Inc., St. Louis, Mo. (USA) as DEQUEST® phosphonates.

The gelled organic-based fluid may also typically contain proppants. The selection of a proppant involves many compromises imposed by economical and practical considerations. Criteria for selecting the proppant type, size, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated, or pre-cured resin coated, provided that the resin and any other chemicals that might be released from the coating or come in contact with the other chemicals are compatible with them. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, or from about 0.12 to about 0.72 kg/L, or from about 0.12 to about 0.54 kg/L. The fluid may also contain other enhancers or additives.

In some embodiments, the gelled organic-based fluid may optionally comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the composition using a gas, such as air, nitrogen, or carbon dioxide. In one certain embodiment, the composition may contain a particulate additive, such as a particulate scale inhibitor.

The gelled organic-based fluid may be used, for example in oilfield treatments. The fluids may also be used in other industries, such as in household and industrial cleaners, agricultural chemicals, personal hygiene products, cosmetics, pharmaceuticals, printing and in other fields.

The gelled organic-based fluid may be used for carrying out a variety of subterranean treatments, where a viscosified treatment fluid may be used, including, but not limited to, drilling operations, fracturing treatments, and completion operations (e.g., gravel packing). In some embodiments, the gelled organic-based fluid may be used in treating a portion of a subterranean formation. In certain embodiments, the gelled organic-based fluid systems may be introduced into a well bore that penetrates the subterranean formation. Optionally, the gelled organic-based fluid systems further may comprise particulates and other additives suitable for treating the subterranean formation. For example, the gelled organic-based fluid systems may be allowed to contact the subterranean formation for a period of time sufficient to reduce the viscosity of the treatment fluid. In some embodiments, the gelled organic-based fluid systems may be allowed to contact hydrocarbons, formations fluids, and/or subsequently injected treatment fluids, thereby reducing the viscosity of the treatment fluid. After a chosen time, the gelled organic-based fluid systems may be break thanks to the chelating agents disclosed herewith. And after another chosen time, the gelled organic-based fluid systems may be recovered through the well bore.

In certain embodiments, the gelled organic-based fluid systems may be used in fracturing treatments. In the fracturing embodiments, the composition may be introduced into a well bore that penetrates a subterranean formation at or above a pressure sufficient to create or enhance one or more fractures in a portion of the subterranean formation. Generally, in the fracturing embodiments, the gelled organic-based fluid systems may exhibit viscoelastic behavior if a VES is used. Optionally, the gelled organic-based fluid systems further may comprise particulates and other additives suitable for the fracturing treatment. After a chosen time, the gelled organic-based fluid systems may be break thanks to the chelating agents disclosed herewith. And after another chosen time, the gelled organic-based fluid systems may be recovered through the well bore.

The gelled organic-based fluid systems are also suitable for gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of “proppant” (natural or synthetic materials that prop open a fracture after it is created) in hydraulic fracturing or “gravel” in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Gravel is also a natural or synthetic material, which may be identical to, or different from, proppant. Gravel packing is used for “sand” control. Sand is the name given to any particulate material from the formation, such as clays, that could be carried into production equipment. Gravel packing is a sand-control method used to prevent production of formation sand, in which, for example a steel screen is placed in the wellbore and the surrounding annulus is packed with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations are frequently poorly consolidated, so that sand control is needed; they may also be damaged, so that fracturing is also needed. Therefore, hydraulic fracturing treatments in which short, wide fractures are wanted are often combined in a single continuous (“frac and pack”) operation with gravel packing. For simplicity, in the following we may refer to any one of hydraulic fracturing, fracturing and gravel packing in one operation (frac and pack), or gravel packing, and mean them all.

To facilitate a better understanding of the embodiments disclosed herewith, the following examples are given. In no way should the following examples be read to limit, or define, the scope of the invention.

### EXAMPLES

A series of experiments were conducted to demonstrate breaking properties of the chelating agents for gelled organic-based fluid systems.

### Example 1

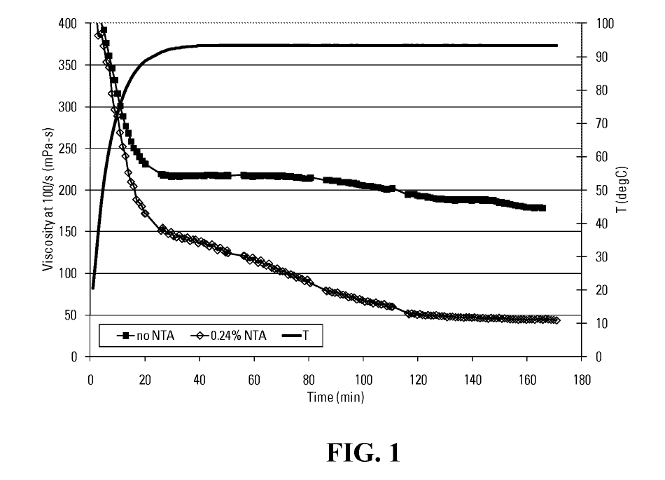

FIG. 1 shows viscosity at 93 deg C. for a sample of gelled oil alone and gelled oil mixed with 0.24% nitrilotriacetic acid (NTA). The gelled oil was prepared with #2 diesel oil, 0.8% acid phosphate ester, and 0.8% ferric (Fe3+) crosslinker solution. The viscosity of the gelled oil or the gelled oil with NTA was measured at 93 deg C. with a Fann50-type viscometer. The 0.24% NTA acted here as the gelled oil breaker that was able to break the gelled oil over time.

### Example 2

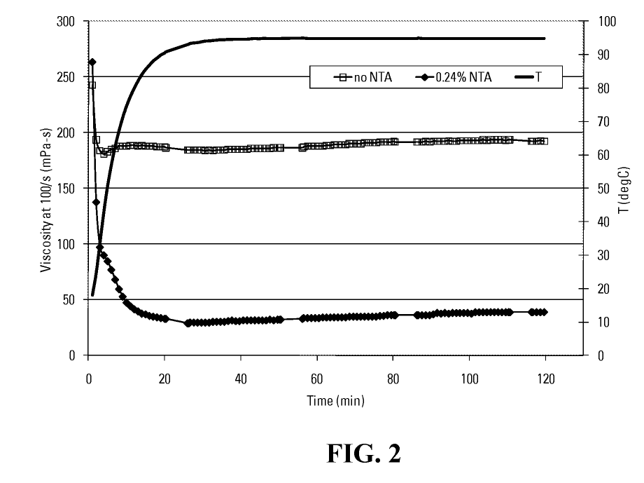

FIG. 2 shows viscosity at 93 deg C. for another sample of gelled oil alone and gelled oil mixed with 0.24% NTA (nitrilotriacetic acid). The gelled oil was prepared with #2 diesel oil, 0.56% phosphoric acid, ethyl, octyl, and decyl esters, and 0.2% crosslinker liquid containing aluminum triisopropanolate. The viscosity of the gelled oil or the gelled oil with NTA was measured at 93 deg C. with a Fann50-type viscometer. The 0.24% NTA acted here as the gelled oil breaker that was able to break the gelled oil over time.

### Example 3

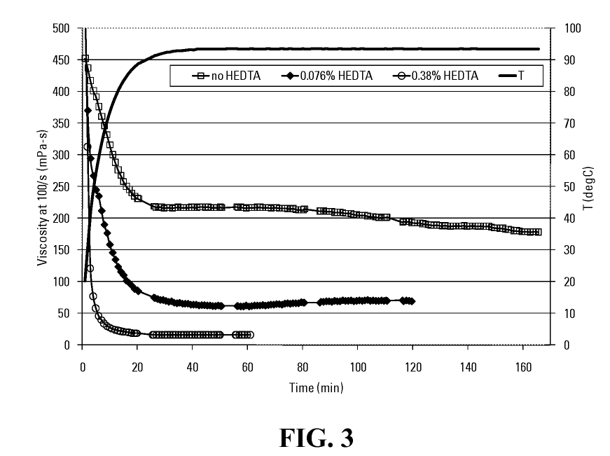

FIG. 3 shows viscosity at 93 deg C. for a sample of gelled oil alone, gelled oil mixed with 0.076% HEDTA (hydroxyethylethylenediaminetriacetic acid), and gelled oil mixed with 0.38% HEDTA, respectively. The gelled oil was prepared with #2 diesel oil, 0.8% acid phosphate ester, and 0.8% ferric (Fe3+) crosslinker solution. The viscosity of the gelled oil or the gelled oil with HEDTA was measured at 93 deg C. with a Fann50-type viscometer. The 0.076% or 0.38% HEDTA acted here as the gelled oil breaker that was able to break the gelled oil over time.

### Example 4

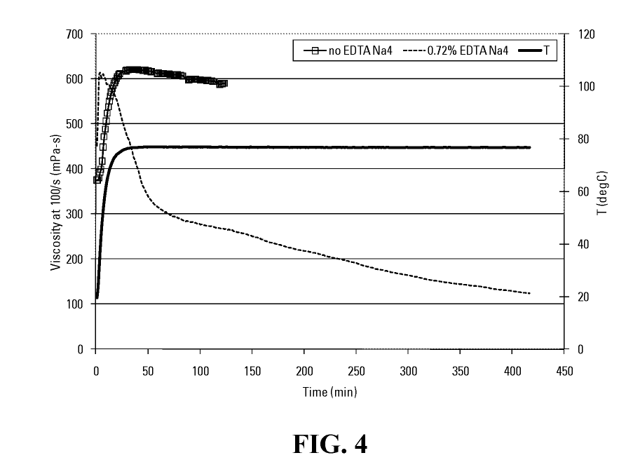

FIG. 4 shows viscosity at 77 deg C. for a sample of gelled oil alone, and gelled oil mixed with 0.72% wt tetrasodium EDTA (EDTA Na4). The gelled oil was prepared with #2 diesel oil, 1% alkyl phosphate ester, and 1% ferric (Fe3+) crosslinker solution. The viscosity of the gelled oil or the gelled oil with tetrasodium EDTA was measured at 77 deg C. with a Fann50-type viscometer. The 0.72% tetrasodium EDTA acted here as the gelled oil breaker that was able to break the gelled oil over time.

### Example 5

The gelled oil was prepared with #2 diesel oil, 0.32%-0.96% phosphoric acid, ethyl, octyl, and decyl esters, 0.1%-0.3% crosslinker liquid containing aluminum triisopropanolate, and 0.04%-0.2% betaine viscoelastic surfactant (VES). In one test, about 0.24%-0.36% citric acid added in the gelled oil slowly lowered (broke) the gelled oil viscosity at 93 deg C. in hours (no figure).

The foregoing disclosure and description of the embodiments is illustrative and explanatory thereof and it can be readily appreciated by those skilled in the art that various changes in the size, shape and materials, as well as in the details of the illustrated construction or combinations of the elements described herein can be made without departing from the scope of the claims.

We claim:

1. A method of decreasing the viscosity of a gelled organic-based fluid, comprising:
a. combining an organic solvent, a gelling agent, and a metal crosslinker;
b. forming the gelled organic-based fluid; and
c. adding a chelating agent forming a complex with the metal to decrease the viscosity of the gelled organic-based fluid.

2. The method of claim 1, wherein the organic solvent is selected from the group consisting of diesel oil, kerosene, paraffinic oil, crude oil, refined oil, gas-condensates, LPG, toluene, xylene, ethers, esters, mineral oil, biodiesel, vegetable oil, animal oil, alcohol, and mixtures thereof.

3. The method of claim 1, wherein the gelled organic-based fluid further comprises a viscoelastic surfactant.

4. The method of claim 3, wherein the viscoelastic surfactant comprises a betaine compound selected from the group consisting of erucic amidopropyl dimethyl betaine, oleoylamidopropyl dimethyl betaine, cocamidopropyl betaine, and mixtures thereof.

5. The method of claim 1, wherein the gelling agent is an alkyl phosphate ester.

6. The method of claim 5, wherein the alkyl phosphate ester is an alkyl diester acid.

7. The method of claim 5, wherein the alkyl phosphate ester is prepared by reacting a C3-18 aliphatic alcohol with phosphorous pentoxide.

8. The method of claim 1, wherein the metal crosslinker is an aluminum or iron crosslinking agent.

9. The method of claim 8, wherein the crosslinking agent contains Fe (II) or Fe (III) or a complex which is capable of releasing Fe (II) or Fe (III).

10. The method of claim 1, wherein the chelating agent is encapsulated.

11. The method of claim 1, wherein the gelled organic-based fluid is foamed, energized, or emulsified.

12. The method in claim 1, wherein the fluid further comprises a foaming agent, an emulsifying agent, or a pH-altering material such as carbonate, bicarbonate, or a Lewis base.

13. The method of claim 1, wherein the chelating agent is nitrilotriacetic acid (NTA), citric acid; ascorbic acid, hydroxyethylethylenediaminetriacetic acid (HEDTA) or its salts, ethylenediaminetetraacetic acid (EDTA) or its salts, diethylenetriaminepentaacetic acid (DTPA) or its salts, phosphinopolyacrylate, thioglycolates, or a combination thereof.

14. A method of treating a subterranean formation from a well, comprising:
a. combining an organic solvent, a gelling agent, and a metal crosslinker;
b. forming the gelled organic-based fluid;
c. introducing the gelled organic-based fluid in to the well; and
d. adding a chelating agent forming a complex with the metal to decrease the viscosity of the gelled organic-based fluid.

15. The method of claim 14, comprising a fracturing step, and wherein introducing the gelled organic-based fluid in to the well is done at a pressure above a fracturing pressure of the subterranean formation.

16. The method of claim 15, further comprising introducing proppant into the well.

17. The method of claim 14, wherein the step of adding the chelating agent is done by introducing the chelating agent into the well.

18. The method of claim 14, wherein the step of adding the chelating agent is done by combining the chelating agent in situ in the well.

19. The method of claim 14, wherein the organic solvent is selected from the group consisting of diesel oil, kerosene, paraffinic oil, crude oil, refined oil, gas-condensates, LPG, toluene, xylene, ethers, esters, mineral oil, biodiesel, vegetable oil, animal oil, alcohol, and mixtures thereof.

20. The method of claim 14, wherein the gelled organic-based fluid further comprises a viscoelastic surfactant.

21. The method of claim 20, wherein the viscoelastic surfactant comprises a betaine compound selected from the group consisting of erucic amidopropyl dimethyl betaine, oleoylamidopropyl dimethyl betaine, cocamidopropyl betaine, and mixtures thereof.

22. The method of claim 14, wherein the gelling agent is an alkyl phosphate ester.

23. The method of claim 22, wherein the alkyl phosphate ester is an alkyl diester acid.

24. The method of claim 22, wherein the alkyl phosphate ester is prepared by reacting a C3-18 aliphatic alcohol with phosphorous pentoxide.

25. The method of claim 14, wherein the metal crosslinker is an aluminum or iron crosslinking agent.

26. The method of claim 25, wherein the crosslinking agent contains Fe (II) or Fe (III) or a complex which is capable of releasing Fe (II) or Fe (III).

27. The method of claim 14, wherein the chelating agent is encapsulated.

28. The method of claim 14, wherein the gelled organic-based fluid is foamed, energized, or emulsified.

29. The method of claim 14, wherein the chelating agent is nitrilotriacetic acid (NTA), citric acid; ascorbic acid, hydroxyethylethylenediaminetriacetic acid (HEDTA) or its salts, ethylenediaminetetraacetic acid (EDTA) or its salts, diethylenetriaminepentaacetic acid (DTPA) or its salts, phosphinopolyacrylate, thioglycolates, or a combination thereof.
